(19) United States
(12) Patent Application Publication
(10) Pub. No.: US 2011/0305311 A1
(43) Pub. Date: Dec. 15, 2011

(54) FUEL ELEMENT FOR A PRESSURIZED-WATER NUCLEAR REACTOR

(75) Inventors: Juergen Stabel, Erlangen (DE); Bernd Dressel, Erlangen (DE); Horst-Dieter Kiehlmann, Forchheim (DE)

(73) Assignee: AREVA NP GMBH, ERLANGEN (DE)

(21) Appl. No.: 13/129,188

(22) PCT Filed: Nov. 11, 2009
(86) PCT No.: PCT/EP2009/064965

§ 371 Date: Jul. 26, 2011

(30) Foreign Application Priority Data
Nov. 13, 2008 (DE) 10 2008 043 711.5
Apr. 28, 2009 (DE) 10 2009 002 698.3

(51) Int. Cl. G21C 3/322

(52) U.S. Cl. 376/439

(57) ABSTRACT

In a fuel element for a pressurized-water reactor, in addition to spacers, flow-guiding structural parts are arranged. The flow guiding parts include four outer webs which, in a plane oriented perpendicularly to the central longitudinal axis, surround a square inner region of which the center point lies on the central longitudinal axis. At their lower longitudinal side facing the flowing cooling water in the operating state, the outer webs are provided with deflection lugs pointing towards the inner region and are structurally identical, wherein mutually opposite outer webs are arranged mirror-symmetrically with respect to a center plane extending in the axial direction. Such a structural part forms, at most for a number of fuel rods which is smaller than their total number in the fuel element, cells through which a respective fuel rod is guided. The number of these cells, which are situated in a row or column, is smaller than the number of the fuel rods respectively situated in this row or column.

The invention relates to a fuel assembly for a pressurized-water nuclear reactor.

It is known from numerous inspection results that the fuel assemblies of a pressurized-water nuclear reactor, over their period of use, bend as a result of their position in the core, so that systematic bending patterns may result for the entire core. This bending may be caused for example by anisotropies in the thermal longitudinal expansion, an increase in length, induced by radioactive radiation, of the fuel rod cladding tubes or the control rod guide tubes, or flow forces, produced by balancing flows transverse to the longitudinal axis of the fuel assemblies. This bending can, in the worst case, result in control rods which are difficult to move or in problems during the replacement of fuel assemblies.

Such a bending or distortion of a fuel assembly, which has been observed in practice, is shown in the graph in FIG. 2. Plotted in this graph is the extent of bending d in mm against the height h of the fuel assembly in m, measured from the lower rod-holding plate, as is the case, for example, for an irradiated 18×18 fuel assembly. The figure shows that this is substantially a C-arc-shaped bending (basic mode), which is to a certain extent superposed by bending of higher modes, mainly of the next higher mode in the shape of an S-shaped bending.

In order to reduce the extent of such bending, attempts have been made in the prior art to provide the fuel assemblies with mechanically more stable designs and to reduce the hold-down forces. Alternatively, DE 10 2005 035 486 B3 proposes to provide the spacers in a fuel assembly with different designs, depending on their position in the fuel assembly, wherein the spacers which are arranged in an upper region have a lower flow resistance to cross-flows than the spacers which are arranged in a lower region. This procedure is based on the observation that cross-flow components are imparted on the cooling water, which flows in the longitudinal or axial direction of the fuel assembly, owing to the substantially C-arc-shaped bending of the fuel assembly, as described in the introduction. In the lower region of the fuel assembly, i.e. in that region in which the extent of the bending, viewed in the direction of the flowing cooling water, i.e. the deflection from a vertical ideal line, increases, these cross-flow components, which are perpendicular to the vertical, run in a direction opposite to the cross-flow components which occur in the region above the maximum of the deflection owing to the now decreasing deflection. The cross-flows thus exert in the lower region a force on the fuel assembly which reduces the extent of the bending in this lower region, while the cross-flows which run in a direction opposite in the upper region cause the bending to increase, with the result that, in practice, the superposition of the C-arc-shaped bending with an S-shaped bending, as described in the introduction with reference to FIG. 2, occurs. The procedure proposed in DE 10 2005 035 486 B3 is accordingly based on the consideration that the extent of the forces which occur in the upper region, and thus the tendency toward instability and toward the formation of a plastic deformation, is reduced if the spacers which are arranged in the upper region oppose the cross-flow with a lower flow resistance than the spacers located in the lower region. However, such a procedure requires a complex new design of the spacers.

The invention is then based on the object of specifying a fuel assembly for a pressurized-water nuclear reactor, which has reduced bending during operation and does not require a design modification of the spacers used in the respective fuel assembly.

The object stated is achieved according to the invention by way of a fuel assembly having the features of patent claim 1. By attaching such a flow-guiding structural part between two spacers, the axially approaching cooling water is increasingly directed into the gap between two neighboring fuel assemblies which has the greater width. As a result, a transverse force, which is directed toward the wider gap, is exerted on the fuel assembly. This transverse force then causes a plastic creep deformation of the fuel assembly, which leads to a reduction in the width of the wide gap on one side of the fuel assembly and to an increase of the narrow gap on the other side.

The invention is based here on the consideration that an important reason for the bending observed in the prior art is the interaction between the flowing cooling water and the fuel assembly, wherein owing to design-related asymmetries of the spacer, which is typically provided with what are referred to as swirl vanes or mixing vanes, a directed force is exerted by the cooling water flowing inside a spacer in the fuel assembly on the fuel assembly even if the fuel assembly and its neighboring fuel assemblies do not yet show any bending. These design-related asymmetries are caused both by the arrangement of the mixing vanes itself and by the knobs and spring elements for mounting the fuel rod, which are located in the cells of the spacer.

The directed force, which acts because of these asymmetries, produces, during operation, directed bending of the fuel assembly or fuel assemblies, which effects a systematic bending of the core, further explained in DE 103 58 830 B3. By inserting one or more such structural parts according to the invention, it is possible to largely compensate for or to minimize the forces, which effect bending in the fuel assemblies known in the prior art, even in cases of minor bending, irrespective of the direction in which the transverse force caused by such asymmetries acts. This is achieved by the structural parts having a symmetric configuration such that, owing to the cooling water flowing axially inside the fuel assembly in the region of the structural part, no transverse forces are exerted on the fuel assembly if the flow conditions on all sides of the fuel assembly are identical, i.e. its neighboring fuel assemblies do not yet show any bending, but transverse forces occur only when different flow conditions, caused by different gap widths, are present in the region of the structural part outside the fuel assembly.

Moreover, the structural parts according to the present invention are not so-called intermediate grids, as are known in the prior art as additional mixing grids or stabilization grids, which either have as many cells as spacers, through which in each case one fuel rod or a control rod guide tube is guided, or in the case of which at least the fuel rods which are located at the edge are guided through cells and mounted in them, as is the case with the vibration-dampening intermediate grid known from U.S. Pat. No. 4,762,669. For example, in the structural parts according to the invention either no cells are formed or at most only a number of cells that is a lot smaller than the number of cells of the spacers and which occur merely for design reasons when the outer webs or any inner webs which may be present of the structural part are fixed, preferably welded, to the control rod guide tubes or other structural tubes in the fuel assembly which are welded fixedly to the spacers. Moreover, the fuel rods are not resiliently mounted in the cells formed by the structural element with the aid of spring elements or projections, as is the case in the intermediate grid known from U.S. Pat. No. 4,762,669. Rather, the fuel rods are guided through these cells without touching the cell walls.

Advantageous embodiments of the invention are stated in the dependent claims.

For the purposes of further explaining the invention, reference is made to the drawing, in which:

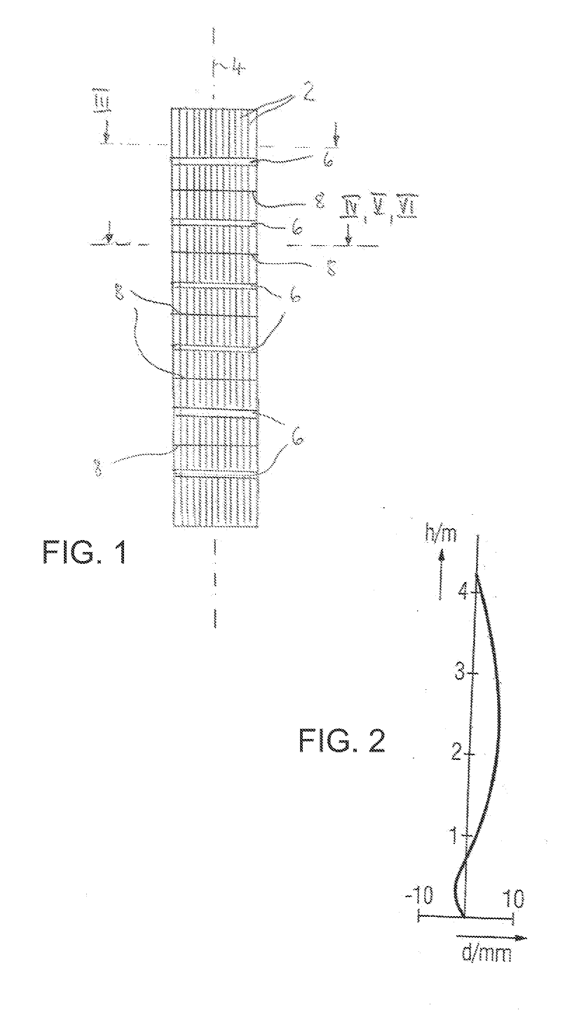

FIG. 1 shows a fuel assembly according to the invention in a schematic principle illustration,

FIG. 2 shows a graph, in which the bending d of a fuel assembly, observed in the prior art, is plotted against the height h of the fuel assembly,

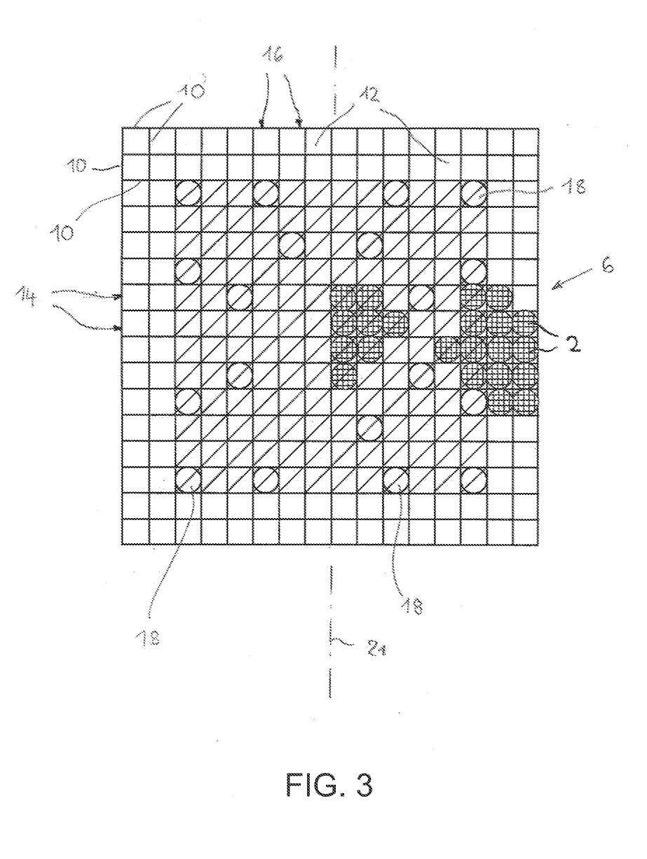

FIG. 3 shows a schematic cross section of a fuel assembly in plan view of a spacer,

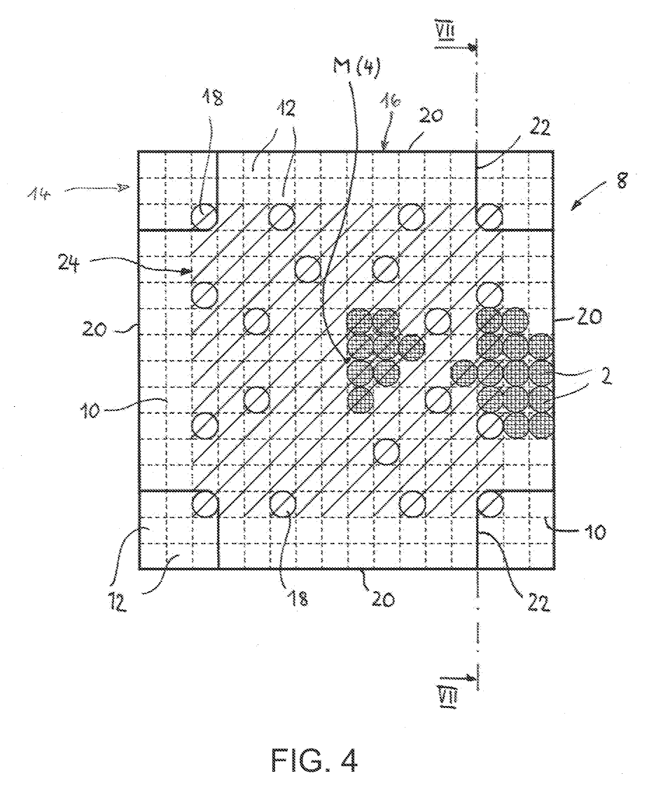

FIGS. 4 to 6 likewise show, in a schematic cross section of a fuel assembly, a plan view of various embodiments of a flow-guiding structural part according to the invention,

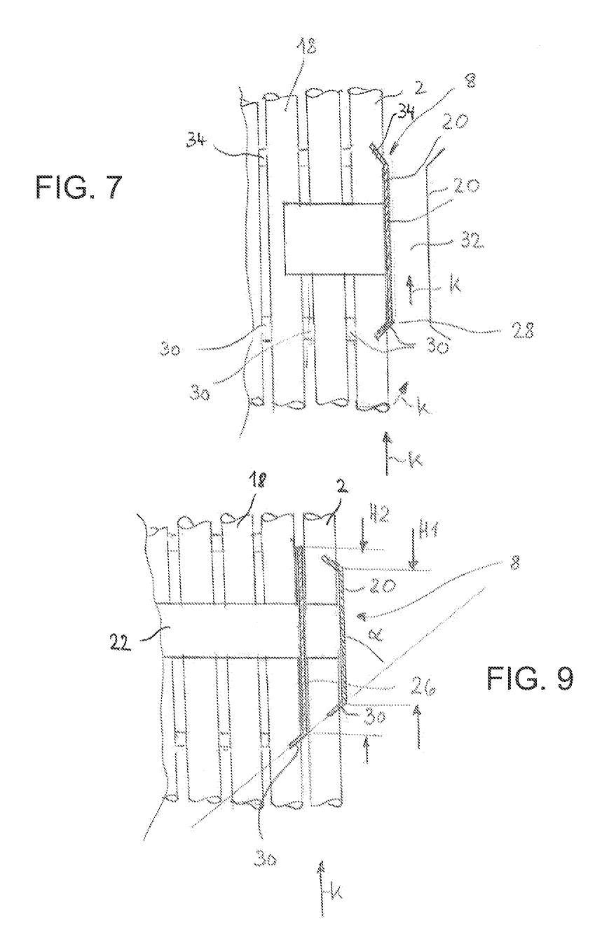

FIG. 7 shows a detail of the longitudinal section through a fuel assembly with a flow-guiding structural part in the configuration according to FIG. 4,

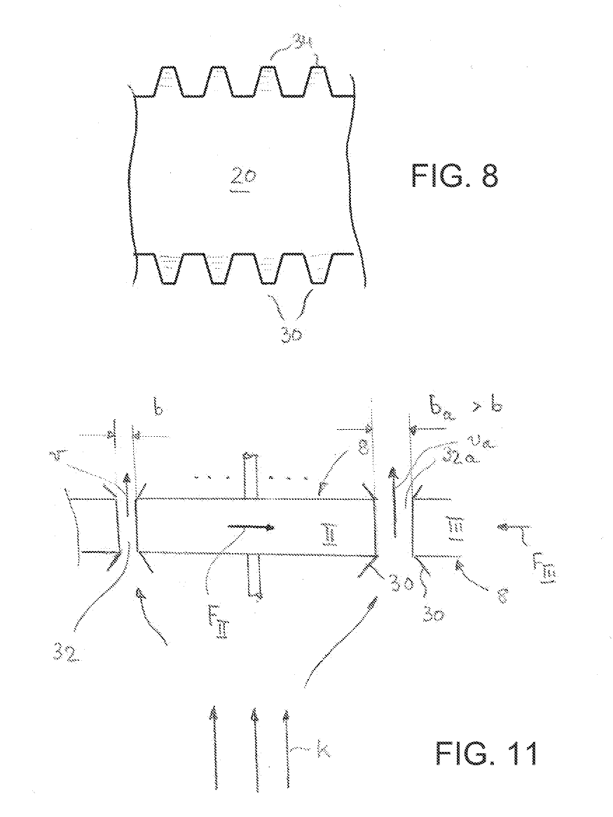

FIG. 8 shows a plan view of an outer web of a flow-guiding structural part, illustrated in FIG. 7, in plan view of the flat side,

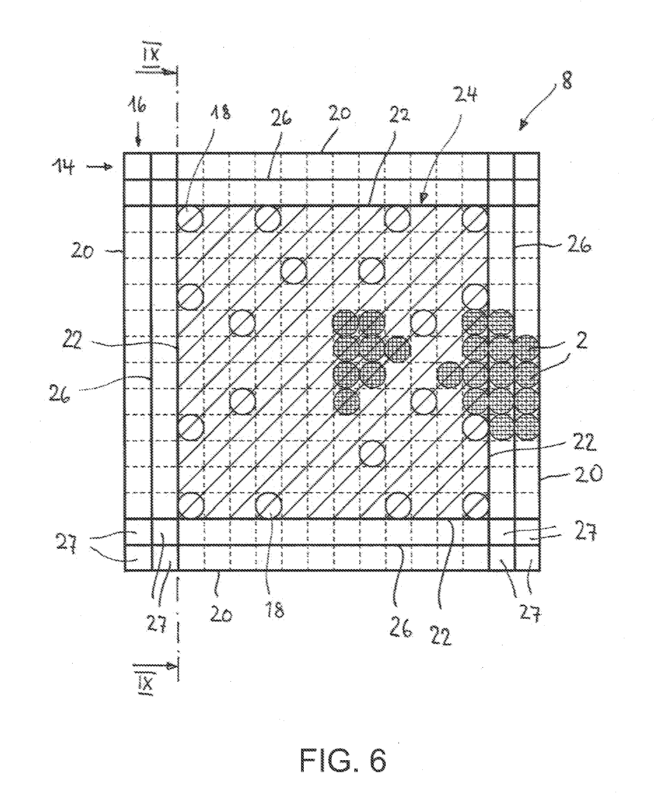

FIG. 9 likewise shows a detail of the longitudinal section through a fuel assembly with a flow-guiding structural part configured as per FIG. 6,

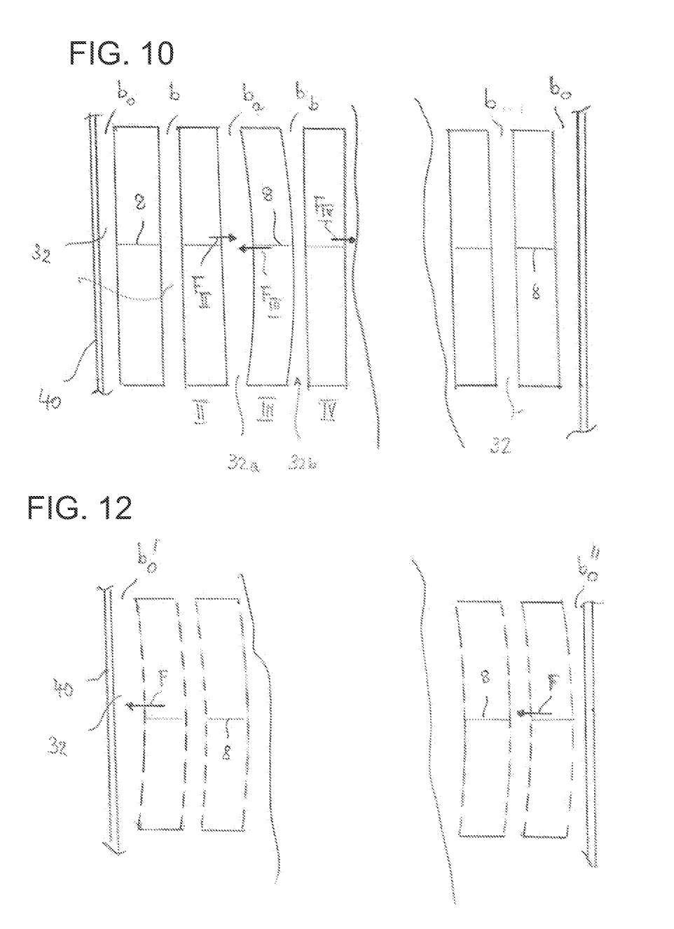

FIG. 10 shows a core of a pressurized-water nuclear reactor in a schematic longitudinal section with a bent fuel assembly,

FIG. 11 shows a principle illustration of mutually neighboring fuel assemblies according to the invention in the region of a structural part according to the invention,

FIG. 12 shows a core of a pressurized-water nuclear reactor with adjacently arranged fuel assemblies which are uniformly bent.

According to FIG. 1, a fuel assembly according to the invention comprises a large number of fuel rods 2, which extend mutually parallel in the direction of a center longitudinal axis 4 and are guided in a plurality of spacers 6 spaced apart in the direction of this center longitudinal axis. Arranged between the spacers 6 is in each case one flow-guiding structural part 8, which is not used for guiding the fuel rods 2, and the function of which will be explained in more detail below. In the figure, all the intermediate spaces between neighboring spacers 6 are provided with a single structural part 8. In principle, however, it is also possible for a plurality of structural parts 8 to be arranged in the fuel assembly between neighboring spacers 6. Likewise, not every intermediate space between neighboring spacers 6 must have such a structural part 8. In that case, the structural parts 8 are preferably arranged in the upper region of the fuel assembly.

The schematic sectional illustration according to FIG. 3 shows a spacer 6 in a highly simplified plan view. This figure shows that the spacer 6 forms a square grid, which is made of grid webs 10 with a large number of square cells 12, which are arranged in rows 14 and columns 16. In each case one control rod guide tube 18 (and any structural tubes which may be present and not shown in the exemplary embodiment of the figure), which is connected, for example welded, to the grid webs 10 which adjoin it, is guided through a number of said cells 12. The fuel rods 2 are in each case guided through the remaining cells 12 and mounted therein in radially resilient manner, with only a small number of the fuel rods being shown in the figure for reasons of clarity. The grid webs 10, which are welded together, contain further structural elements (not shown in more detail in the simplified illustration of the figure), for example knobs and springs for mounting the fuel rods 2, and flow-guiding elements, for example vanes arranged on the upper side thereof, i.e. on the side which is remote during operation from the flowing cooling water, in order to produce mixing of the cooling water in the flow from the spacer 6. Moreover, the grid webs 10 located at the edge are provided with vanes (not shown in the figure), which point at an angle into the fuel assembly and are intended to prevent the fuel assemblies from getting caught during fuel assembly replacement. Rather than the one-walled grid webs 10 shown in the figure, it is also possible for these grid webs to be of double-walled design with inside flow channels, as is the case for example in the spacer known from EP 0 237 064 A2.

The exemplary embodiment of a flow-guiding structural part 8 according to the invention, shown in FIG. 4 likewise in schematic plan view, illustrates that this structural part 8 is made up substantially exclusively of four outer webs 20, which span a plane that is oriented perpendicular to the center longitudinal axis 4 and which surround a square inner region of the fuel assembly, the center point M of which is located on the center longitudinal axis 4. In the example shown, the outer webs 20 are arranged on the lateral edge of the fuel assembly and form a contiguous frame which encloses all cells 12 of the fuel assembly. In principle, the outer webs 20 can also be shorter than the lateral dimensions of the fuel assembly such that the outer webs 20 do not enclose the fuel assembly if they are arranged at the edge. Moreover, the outer webs 20 can also be arranged inside the fuel assembly, for example a row 14 or column 16, and spaced apart from the edge, and form a contiguous frame in this case, too.

The outer webs 20 are identical in terms of design and mutually opposite outer webs 20 are arranged in mirror-symmetrical fashion with respect to a center plane 21 which extends in the axial direction.

Rail-type holders 22, which are welded to control rod guide tubes 18 in order to fix in this manner the structural part 8 in the fuel assembly, are fixed to the outer webs 20. In this example, these are the control rod guide tubes 18 that are arranged at the corner points of a square inner region 24, which is emphasized by hatching and is defined by the control rod guide tubes 18, with all the control rod guide tubes 18 being located inside this inner region 24. Accordingly, the holders 22 extend only up to the control rod guide tubes 18 located at the corner points and are therefore shorter than the grid webs 10 illustrated in the figure. The holders 22 do not necessarily have to lead up to the control rod guide tubes 18 located at the corner points of the inner region 24, but can in principle also be welded to other control rod guide tubes 18 located at the edge or inside the inner region 24. One or more than two holders 22 can likewise be provided per outer web instead of two holders 22.

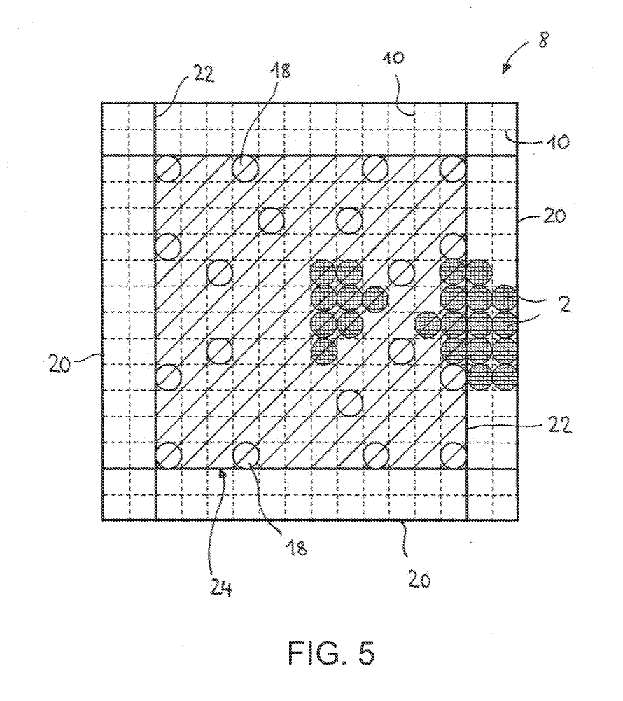

In the exemplary embodiment according to FIG. 5, the holders 22 are designed as narrow web plates, which extend parallel to the hatched interior grid webs 10 at the edge of the inner region 24 and over the entire width of the fuel assembly, i.e. have the same longitudinal extent as the grid webs 10.

In the exemplary embodiments according to FIGS. 4 and 5, owing to the structural parts 8, no cells which correspond to the cells 12 of the spacers are formed, through which in each case only one fuel rod 2 is guided.

In the exemplary embodiment according to FIG. 6, in addition, inner webs 26, which are welded to one another, to the outer webs 20 and to the holders 22, which are likewise designed as web plates according to FIG. 5, and likewise produce a contiguous frame, which surrounds a squarer inner region of the fuel assembly, are provided with a spacing of in each case one row 14 or one column 16 and parallel to each outer web 20 which is arranged at the lateral edge of the fuel assembly. The holders 22 and the inner webs 26 form, in the corner regions of the fuel assembly, in each case four cells 27, through which a respective fuel rod is guided. The number of the cells 27 formed by the structural element 8 is here always significantly smaller than the total number of fuel rods in the fuel assembly in order to keep the flow resistance produced by the structural part 8 as low as possible.

As an alternative to the embodiment shown in the figure, the inner webs 26 can also be combined with the short holders 22 from FIG. 4.

In all exemplary embodiments, the number of the cells 27 which are located in one row 14 or column 16 and are formed by the structural element 8 is smaller than the number of the fuel rods which are in each case located in this row 14 or column 16. In other words, the number of the fuel rods 2, which are enclosed between outer web 20, inner web 26, if present, and holders 22, is significantly greater than the cells 27 which may be formed by the structural part 8.

FIG. 7 shows that each outer web 20 of the structural part 8 shown in FIG. 4 is provided on its lower edge 28, i.e. its longitudinal side which during operation faces the upwardly flowing cooling water K, with deflector vanes 30 which point in the direction of the interior of the fuel assembly. These deflector vanes 30 project into intermediate spaces or gaps between the fuel rods 2 which are arranged at the edge of the fuel assembly. They are used to direct the cooling water K into a gap 32 formed by the outer webs 20 between neighboring fuel assemblies. The figure shows schematically the outer web 20 of a neighboring fuel assembly. FIG. 7 also shows that the outer web 20 is welded to a holder 22 in the form of a narrow plate on a control rod guide tube 18. The height of the plate is here preferably smaller than the height of the grid webs used in the spacers, so as to minimize the flow resistance produced owing to the additional structural parts with sufficient stability.

The upper longitudinal side of the outer web 20 is preferably provided, just as the lower longitudinal side, with inwardly directed vanes 34 which are used, in contrast with the lower deflector vanes 30, primarily as slide slopes for facilitating installation of the fuel assemblies into the core and removal therefrom.

In the plan view of an outer web 20 according to FIG. 8, it can be seen that the deflector vanes 30 and vanes 34 arranged on the longitudinal sides have a trapezoid-like shape.

FIG. 9 shows that the inner web 26 next to the outer web 20 in the exemplary embodiment according to FIG. 6 is on its lower longitudinal side likewise provided with deflector vanes 30 which point into the interior of the fuel assembly.

The height H1 of the outer web 20 is preferably smaller than the height H2 of the inner web 26. The differences in height are matched to one another with the dimensions and inclination angles α of the deflector vanes 30 such that they are located approximately in a common plane in order to effect in this manner efficient deflection of the cooling water K approaching from below into the gap that is located between outer webs 20 of neighboring fuel assemblies.

Both the outer webs 20 and the inner webs 26 are in each case identical in terms of design and are configured in mirror-symmetrical fashion with respect to a center plane of the fuel assembly which extends in the axial direction, with the result that the transverse forces exerted thereby on the fuel assembly owing to deflection of the cooling water which is approaching from below cancel each other out if the flow conditions are identical on all sides of the fuel assembly.

The mode of action of a fuel assembly provided with a structural part 8 according to the invention is illustrated schematically in FIGS. 10 to 12 for an idealized core in a pressurized-water nuclear reactor, the fuel assemblies of which are structurally designed such that, if the case arises where all fuel assemblies in the core show no bending and the gaps between the fuel assemblies are of the same size, no hydraulic transverse forces are exerted on the fuel assembly by the cooling water which flows axially in or past such an ideal or equilibrated fuel assembly.

FIG. 10 shows a situation in which one of the fuel assemblies arranged in the core, in the present example the fuel assembly located at position III, has a typical initial bending, as has been observed in real fuel assemblies, while the remaining ideal fuel assemblies, which are in each case next to one another in a row, still have a straight shape. In this idealized situation, the gaps have in each case the same width b between the straight fuel assemblies and the width b₀ between a core shroud 40 and the fuel assemblies located at the edge of the core. Owing to the bending of the fuel assembly in position III, the gaps 32a, b between this fuel assembly and the neighboring fuel assemblies in positions II and IV have gap widths of bₐ≠b_{b}. These differing gap widths bₐ>b and b_{b}<b now exert a force F_{II} or F_{IV}, which is directed to the right, on the fuel assemblies in positions II and IV, respectively, while a force F_{III}, which is directed to the left, acts on the fuel assembly in position III.

This is illustrated in more detail in FIG. 11 for the fuel assemblies in positions II and III. The cooling water K approaching from below is accelerated by the deflector vanes 30 which are inclined into the interior of the structural part 8. Here, the cooling water K will preferably flow in the direction of the wider gap 32a because its hydraulic resistance is less than the hydraulic resistance of the narrower gap 32. In this narrower gap 32, the cooling water K consequently flows at a lower speed v<vₐ than in the gap 32a. As a result, the pressure is lower in the wider gap 32a than in the gap 32, and therefore a force F_{II} which is directed to the right in the figure is exerted on the fuel assembly in position II. Accordingly, a force F_{III} which is directed to the left is exerted on the fuel assembly located in position III.

The forces F_{II} and F_{IV} which act on the fuel assemblies in the positions II and IV respectively would now result in a bending of the fuel assemblies which were not previously bent, and this bending would spread to all the fuel assemblies in the core, until in a state of equilibrium all fuel assemblies had a C-arc-shaped bending in the same direction, as is illustrated in FIG. 12 by the fuel assemblies shown in dashed lines.

Such a unidirectional bending would in turn result in the gap 32 according to FIG. 12 between the fuel assembly in the position I and the core shroud 40 broadening to a width b₀′>b₀. Accordingly, the gap 32 between the fuel assembly located at the right-hand edge and the core shroud 40 would narrow to a width b₀″<b₀. In this way, forces F, which are directed to the left in each case in the illustrated example and counteract the previously mentioned effect, would act on the outer fuel assemblies, with the result that an equilibrium situation in the core is brought about by the boundary condition produced by the core shroud 40, in which all the fuel assemblies regain a substantially straight alignment. This process of self-straightening obviously comes about when all gaps, i.e. both the gaps between neighboring fuel assemblies and the gaps between the fuel assemblies located at the edge of the core and the core shroud, are approximately of the same size.

The situation illustrated in FIGS. 10 and 12 represents idealized conditions which accordingly presuppose ideal fuel assemblies, in which the hydraulically caused effects which have been observed in the prior art do not occur. If the fuel assemblies known in the prior art, in which the hydraulically caused transverse forces, which were explained in the introduction, occur even with straight alignment and identical gap widths, are provided with structural parts 8 according to the invention, bending may not be prevented completely but reduced to an acceptable degree. Such an effect which reduces the bending of the fuel assemblies in a core is already exerted when only part of the core is provided with fuel assemblies according to the invention or not all of the fuel assemblies in the core have one or more structural parts 8 according to the invention.

The fundamental idea pertaining to the present invention is that, if bending occurs and different gap widths arise, a hydraulically caused force, which opposes the force which produces the bending, is exerted on the fuel assemblies owing to the presence of the flow-guiding structural parts 8 according to the invention, with the result that in an equilibrium state only non-critical bending can occur and the entire core always has the tendency to straighten itself.

1-8. (canceled)

9. A fuel assembly for a pressurized-water nuclear reactor, comprising:
a plurality of spacers spaced apart in a direction of a center longitudinal axis, and a multiplicity of fuel rods guided in said plurality of spacers;
each of said spacers forming a square grid made of grid webs with a multiplicity of cells arranged in rows and columns;
a flow-guiding structural part disposed at least between two axially spaced-apart spacers;
said flow-guiding structural part including four outer webs that surround, in a plane oriented perpendicular to the center longitudinal axis, a square inner region having a center point located on the center longitudinal axis;
said outer webs carrying deflector vanes on a lower longitudinal side thereof facing a flow of cooling water in operation, said deflector vanes pointing in a direction of the inner region;
said outer webs being identical in terms of design and mutually opposite said outer webs being disposed in mirror-symmetrical fashion with respect to a center plane that extends in the axial direction;
said structural part forming, at most for a number of fuel rods that is smaller than an overall number of fuel rods in the fuel assembly, cells through which in each case one fuel rod is guided;
wherein a number of said cells that are disposed in a row or column is smaller than a number of the fuel rods in each case disposed in the respective said row or column.

10. The fuel assembly according to claim 9, wherein said cells, which are formed by the structural part, are located exclusively in corner regions of the fuel assembly.

11. The fuel assembly according to claim 9, wherein said outer webs are arranged at a lateral edge of the fuel assembly.

12. The fuel assembly according to claim 9, wherein said outer webs form a contiguous frame.

13. The fuel assembly according to claim 9, wherein an inner web is associated with each outer web, said inner web is parallel to said inner web and said inner web is provided, on a lower longitudinal side thereof, which faces the flowing cooling water, with deflector vanes pointing in the direction of the inner region, wherein said inner webs are identical in terms of design and mutually opposite inner webs are arranged in mirror-symmetrical fashion with respect to a center plane that extends in the axial direction.

14. The fuel assembly according to claim 13, wherein only fuel rods of a row or column are arranged between said outer web and said inner web.

15. The fuel assembly according to claim 13, wherein said lower longitudinal side of said inner web is arranged below said lower longitudinal side of said outer web.

16. The fuel assembly according to claim 13, wherein said inner webs form a contiguous frame.
